(19) United States
(12) Patent Application Publication
(10) Pub. No.: US 2016/0034854 A1
(43) Pub. Date: Feb. 4, 2016

(54) JOB HOSTING SERVICE FOR PAID AND UNPAID JOB POSTINGS

(71) Applicant: Linkedln Corporation, Mountain View, CA (US)

(72) Inventor: Sachit Kamat, San Carlos, CA (US)

(73) Assignee: Linkedln Corporation, Mountain View, CA (US)

(21) Appl. No.: 14/586,598

(22) Filed: Dec. 30, 2014

Related U.S. Application Data
(60) Provisional application No. 62/031,810, filed on Jul. 31, 2014.

(51) Int. Cl. G06Q 10/10; G06Q 50/00; G06F 17/30

(52) U.S. Cl. CPC G06Q 10/1053; G06F 17/30864; G06Q 50/01

(57) ABSTRACT

A system receives, via a user input, job profiles for job postings to a social network. The system then determines whether each job profile is for a paid job posting to the social network or for an unpaid job posting to the social network. Unpaid job postings are presented to users of the social network only via a job search user interface; paid job postings are presented to users of the social network via the job search user interface and via other channels of the social network, such as e-mail. The presentation via other channels is based a comparison of user profiles to job profiles. The system also extracts job profiles for job postings to the social network, from at least one external website, and presents these job postings to users of the social network only via the job search user interface.

### CROSS REFERENCE TO RELATED APPLICATIONS

This application claims the benefit of U.S. Provisional Application No. 62/031,810, filed Jul. 31, 2014, the entire disclosure of which is incorporated herein by reference thereto.

### TECHNICAL FIELD

The present disclosure generally relates to data processing systems for hosting job postings. More specifically, the present disclosure relates to methods, systems and computer program products that provide a job hosting service with bifurcated functions and features for paid and unpaid job postings, such that paid job postings are subject to the benefits of a first set of functions and features, while unpaid job postings are subject to the benefits of a second set of functions and features.

### BACKGROUND

With a typical job hosting service, a representative of a company will post a job listing to the job hosting service so that users of the job hosting service may search for, browse, and in some cases, apply for the job associated with the particular job listing. In exchange for making the job listing available for presentation to the users of the job hosting service, the company on whose behalf the job listing is posted will typically pay a fee. With some job hosting services, different price points may provide different benefits in terms of how the job listing is handled. For example, the amount of the fee may be tied to the length of time that the job listing is active on the job hosting service. In some instances, an auction mechanism may be used to bid for placement of job listings in a set of search results presented in response to a particular keyword search.

### BRIEF DESCRIPTION OF THE DRAWINGS

Some embodiments are illustrated by way of example and not limitation in the figures of the accompanying drawings.

FIG. 1 is a block diagram of a system including user devices and a social network server.

FIG. 2 is a block diagram illustrating various components of a social networking server with a job posting module and a job extraction module.

FIG. 3 is a block diagram showing some of the functional components or modules that make up a job extraction module.

FIG. 4 is a detailed example of a portion of a user interface screen for the job publishing module.

FIG. 5 is a detailed example of a portion of a user interface screen for the job publishing module.

FIG. 6 is a flow diagram illustrating an example of the method operations involved in a method of hosting paid and unpaid job postings.

FIG. 7 is a flow diagram illustrating an example of the method operations involved in a method of extracting job profiles from external data sources.

FIG. 8 is a block diagram illustrating components of a machine able to read instructions from a machine-readable medium.

### DETAILED DESCRIPTION

The present disclosure describes methods, systems and computer program products that individually provide a job hosting service that provides differing levels of service to paid and unpaid job listings (sometimes referred to as job postings). In the following description, for purposes of explanation, numerous specific details are set forth in order to provide a thorough understanding of the various aspects of different embodiments of the present invention. However, it will be evident to one skilled in the art that the present inventive subject matter may be practiced without all of the specific details.

Consistent with some embodiments, a job hosting service hosts both paid and unpaid job listings. For example, via a job posting module of the job hosting service, users of the job hosting service may provide information about a particular job opening and generate a paid job listing. A job listing typically comprises the name of the company or organization at which the job opening is available, the job title for the job opening, a description of the job functions and the required or recommended skills, education, certifications and/or expertise. In exchange for the payment of the fee, the paid job posting will be eligible for presentation to members of a social networking service with which the job hosting service is integrated.

In addition to paid job postings, the job hosting service may ingest job listings from various externally hosted third-party job sites. In some instances, an automated bot may automatically “crawl” and discover job listings for ingestion, while in other instances, job listings may be obtained from a data feed maintained by one or more third-party partners. In any case, the job hosting service will have a database containing both paid job listings—that is, job listings that have been generated through a job posting module and for which a fee has been obtained—and, unpaid job listings—that is, job listings obtained from a third-party site.

With some embodiments, the unpaid job postings are only eligible for presentation to members (e.g., users) of a social networking service through a job search interface. Accordingly, the unpaid or free job listings will typically only be presented to members that might be referred to as active job seeking candidates or active job seekers. These active job seekers are members who are typically actively engaged in the process of looking for new career opportunities. The paid job postings are also eligible for presentation to members of the social networking service through the search interface, but are also presented to members through various other channels. For example, a recommendation engine may compare user profiles with job postings with the objective of presenting a user of the social networking service with a number of relevant job listings—that is, job postings that might be of interest to the user, based on that user's profile data.

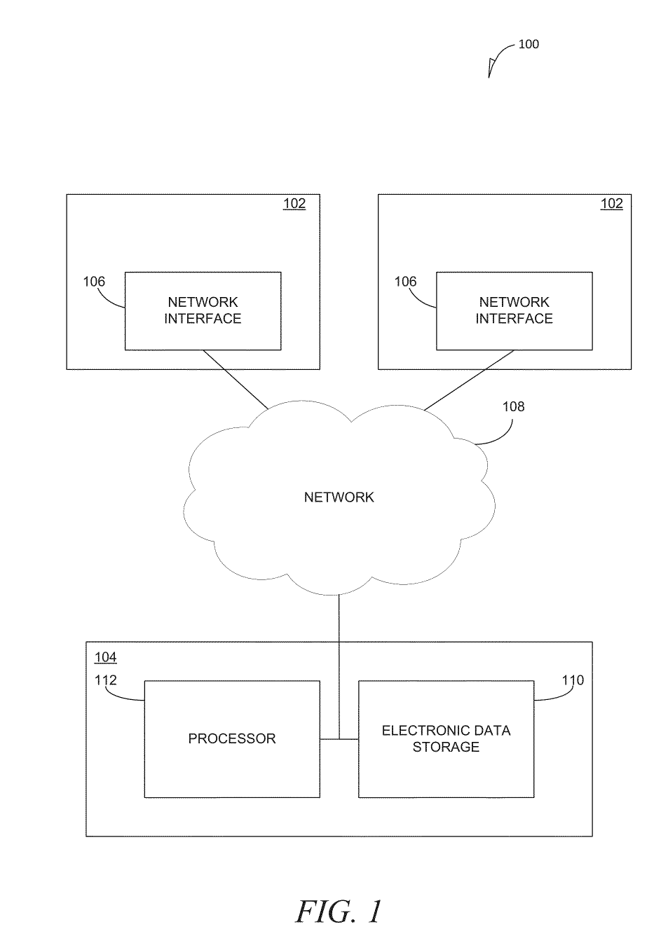

FIG. 1 is a block diagram of a system 100 including user devices 102 and a social network server 104. User devices 102 may be a personal computer, netbook, electronic notebook, smartphone, or any electronic device known in the art that is configured to display web pages. The user devices 102 may include a network interface 106 that is communicatively coupled to a network 108, such as the Internet.

The social network server 104 may be communicatively coupled to the network 108. The server 104 may be an individual server or a cluster of servers, and may be configured to perform activities related to serving the social network, such as storing social network information, processing social network information according to scripts and software applications, transmitting social network information to users of the social network, and receiving information from users of the social network. The server 104 may include one or more electronic data storage devices 110, such as a hard drive, and may also include at least one processor 112.

The social network server 104 may store information in the electronic data storage device 110 related to users of the social network, such as in the form of user profiles corresponding to individual users of the social network. For instance, for an individual user, the user's profile may include one or more profile data points, including, for instance, name, age, gender, profession, prior work history or experience, educational achievement, location, citizenship status, leisure activities, likes and dislikes, and so forth. The user's profile may further include profile data points based on behavior or activities within and outside of the social network, as well as the user's social graph. For a user organization, such as a company, the profile data points may include name, products offered for sale, available job postings, organizational interests, forthcoming activities, and the like. For a particular available job posting, the job posting may be based on a job profile that includes one or more profile data points, such as, for instance, area of expertise, prior experience, pay grade, residency or immigration status, and the like.

User profiles described above may generally include one or more profile data points that may be defined by a single discrete label, such as a number, a place, or a binary status. User profiles described above may also include profile data points related to user behavior, such as may be identified based on user activity within the social network generally. For instance, a user who engages in job searches, such as by entering job keywords into a search engine either of the social network or independent of the social network, may be deemed to have profile data points such as currently seeking a job, and may also include job profile data points associated with jobs that the user is seeking, such as job field, pay grade, location, and the like. Additional user behavior or activities, such as messages to job recruiters, job applications filled out or submitted, and messages to particular companies may also be incorporated. As such, user actions both within and outside of the social network may be utilized to determine user profile data points such as data points based on user behavior.

Activity and behavioral data may be obtained by monitoring and tracking the interactions that a user has with various applications, services and/or content that are provided by, or, integrated or otherwise associated with, the social network service. For example, a social network may provide any number and variety of applications and/or services with which a member interacts. Similarly, a variety of third-party applications and services may leverage various aspects of the social network, for example, via one or more application programming interfaces (APIs). A few examples of such applications or services include: search engine applications and services, content sharing and recommendation applications (e.g., photos, videos, music, hyperlinks, slideshow presentations, articles, etc.), job posting and job recommendation applications and services, calendar management applications and services, contact management and address book applications and services, candidate recruiting applications and services, travel and itinerary planning applications and services, and many more.

Analysis of social graph data may signal a member's interest in various subjects or categories. For instance, in some examples, by analyzing certain social graph data, activities may be identified that are suggestive of active job-seeking activity. For example, members who are actively seeking particular jobs may be more likely to follow other members of the social network, or establish new connections with other members in a very concentrated or shortened time span—particularly other members who are job recruiters for particular job types, or who are associated with a job recruiting function. Similarly, members who are actively seeking jobs of a particular type may be more likely to follow certain companies at which there are open job positions matching the member's skills, or having the same job title as may be desired by the member. Members who are actively seeking particular job types may be more likely to join certain online groups—particularly those groups that exist primarily to aid job seekers. Accordingly, by analyzing social graph data to identify the entities with which a member is establishing associations or connections, and the timing and frequency of the activity, the job-seeking intentions of a member may be inferred, and used in the derivation of a metric representing the member's job-seeking propensity. In an example embodiment, this metric may then be used to target a user for certain premium job postings that may be attractive to the user.

In various embodiments, the system 100 includes logic that may identify user profiles that conform to a given job profile. In various examples, upon receiving a request to identify user profiles similar to a particular job profile, the system 100 may analyze (e.g., compare) a variety of user profiles to select one or more user profiles that have the highest compatibility with respect to the job profile. The identification may be in real-time, understood to be an analysis that is conducted essentially immediately upon receiving the job profile. After identifying the most similar user profiles (e.g., those with the highest compatibility scores), the system 100 may transmit information related to the job (e.g., a job posting) to the selected users via communication channels of the social network other than a standard job search user interface. In an example embodiment, this information is only forwarded to the selected users if the job posting is a premium job posting for which a fee has been paid.

In various examples, the system 100 may generate a list of user profiles with the highest compatibility scores with respect to a job profile. The list may be used to identify users who have user profiles that are desirable for recruiting and to whom messages relating to the job may be presented via communication channels of the social network.

The ability to accurately identify in real-time or essentially real-time a set of user profiles most similar to a job profile (or, in various examples, a set of company profiles most similar to user profiles) may be achieved with a general recommendation engine. Accordingly, at least in some examples, the recommendation engine provides a recommendation service that may be customized for use with multiple applications or services. A recommendation engine may include a collection of information organized around a particular concept that is supported by the system 100 in general, and the recommendation engine in particular. For instance, some examples of collected information are: user profiles, interest groups, company profiles, advertisements, events, news, discussions, tweets, questions and answers, and so forth. Accordingly, in some examples, by specifying that two particular profiles of two entities (e.g., a user and a company) be compared, and by specifying a particular algorithm for use in generating a compatibility score, the recommendation engine 200 may generate a compatibility score for the two profiles. Accordingly, the recommendation engine may be configured and customized to generate compatibility scores for use in recommending job postings to targeted users of the social network.

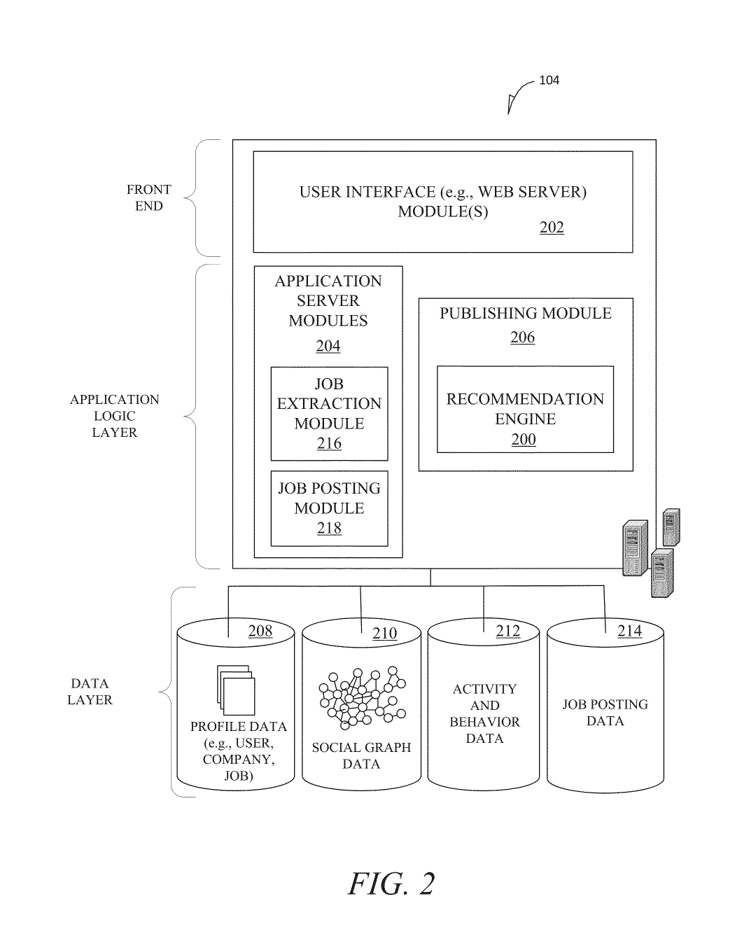

FIG. 2 is a block diagram illustrating various components of the social network server 104 with a publishing module 206 for distributing information via the communication channels of the social network server 104 and a recommendation engine 200 for identifying similarities between different entity profiles, such as user profiles and job profiles. In an example, the social network server 104 is based on a three-tiered architecture, consisting of a front-end layer, application logic layer, and data layer. As is understood by skilled artisans in the relevant computer and Internet-related arts, each module or engine shown in FIG. 2 may represent a set of executable software instructions and the corresponding hardware (e.g., memory and processor) for executing the instructions. To avoid obscuring the subject matter with unnecessary detail, various functional modules and engines that are not germane to conveying an understanding of the inventive subject matter have been omitted from FIG. 2. However, a skilled artisan will readily recognize that various additional functional modules and engines may be used with a social network server 104 such as that illustrated in FIG. 2, to facilitate additional functionality that is not specifically described herein. Furthermore, the various functional modules and engines depicted in FIG. 2 may reside on a single server computer, or may be distributed across several server computers in various arrangements.

The front end of the social network server 104 consists of a user interface module(s) (e.g., a web server) 202, which receives requests from various client computing devices, and communicates appropriate responses to the requesting client devices. For example, the user interface module(s) 202 may receive requests in the form of Hypertext Transport Protocol (HTTP) requests, or other web-based, application programming interface (API) requests. The application logic layer includes various application server modules 204 (e.g., 216 and 218), which, in conjunction with the user interface module(s) 202, generate various user interfaces (e.g., web pages) which may display data retrieved from various data sources (e.g., 208, 210, 212, 214) in the data layer. With some embodiments, individual application server modules 204 are used to implement the functionality associated with various services and features of the system 100. For instance, the ability to identify user profiles similar to a job profile may be a service implemented in an independent application server module 204. Similarly, other applications or services that utilize the recommendation engine 200 may be embodied in their own application server module(s) 204.

The data layer may include several databases, such as a profile data 208 for storing user profiles and job profiles, as well as profiles for additional social network “entities”, such as interest groups, companies, advertisements, events, news, discussions, tweets, questions and answers, and so forth. In some examples, the profile data 208 is processed in the background (e.g., offline) to generate pre-processed profile data (e.g., including calculated data points as well as raw data), that may be used by the recommendation engine 200, in real-time, to make recommendations generally, and to identify user profiles similar to a job profile. In an example, the recommendation engine 200 may retrieve and process a user's social graph data 210 and a user's activity and behavior data 212 to identify user profiles similar to a job profile. Furthermore, one or more job postings and any associated metadata (e.g., date first posted, number of views, etc.) may be stored in job posting data 214.

In various examples, when a person (e.g., a user) initially registers to become a user of the system 100, the person may be prompted to provide some personal information, such as his or her name, age (such as by birth date), gender, interests, contact information, home town, address, the names of the user's spouse and/or family users, educational background (such as schools, majors, etc.), employment history, skills, professional organizations, and so on. This information may be stored, for example, in the profile data 208.

Once registered, a user may invite other user, or be invited by other users, to connect via the system 100. A “connection” may involve a bi-lateral agreement by the users, such that both users acknowledge the establishment of the connection. Similarly, with some embodiments, a user may elect to “follow” another user. In contrast to establishing a “connection”, the concept of “following” another user typically is a unilateral operation, in some examples, does not require acknowledgement or approval by the user that is being followed. This information may be stored, for example, in the social graph data 210 and additionally or alternatively in activity and behavior data 212.

In an example embodiment, the social network server 104 may receive, via a user interface module(s) 202 generated by a job posting module 218, a job profile for each of a plurality of job postings to the social network. A job profile, used to generate a job posting (e.g., listing) typically is composed of profile data points including the name of the company or organization at which the job opening is available, the job title for the job opening, a description of the job functions and the required or recommended skills, education, certifications and/or expertise. After a user enters the relevant job profile data points via the user interface module(s) 202, a job posting may be generated for presentation (via publishing module 206) to users of the social network with which the job posting module 218 is integrated.

In an example embodiment, the publishing module 206 of social network server 104 may then determine whether each job profile received via the job posting module 218 is for an unpaid job posting to the social network, and if so, the job posting may be presented to user of the social network only via a standard “job search” user interface module(s) 202. In this way users of the social network that are actively searching for jobs (e.g., via a job search module in application server modules 204) maybe presented with the unpaid job posting, to the extent that it matches the user's search criteria. However, the unpaid job posting will not be published over other communication channels via the social network server's publishing module 206.

In an example embodiment, the publishing module 206 may then determine whether each job profile received via the job posting module 218 is for a paid job posting to the social network, and if so, the job posting may be presented to users of the social network via the standard “job search” user interface module(s) 202 so that users of the social network that are actively searching for jobs may be presented with the unpaid job posting. Furthermore, payment of a fee will entitle the job posting to be presented to users of the social network over other communication channels of the social network via the publishing module 206. For example, a paid job posting may be presented to a user via a direct e-mail to the user or via placement of the posting on the user's social network “homepage”, if it is determined that the job posting may be attractive to the user based on a comparison (e.g., by recommendation engine 200) of the user's profile and the job profile associated with the job posting.

In an example, the recommendation engine 200 may operate to compare profiles and make recommendations (e.g., to the publishing module 206) based on the comparisons. The data representing each individual instance of a particular social network entity, such as a user profile or a job profile from profile data 208, is processed by the recommendation engine 200 to access the relevant profiles on which a similarity (e.g., compatibility) analysis is to be performed. In various examples, in the case of a user profile, only certain sections or portions of a user's profile may be selected for use in determining the similarity of any two profiles, such as the user profile and a job profile. As such, the recommendation engine 200 may process each user profile to access the relevant profile data points from each user profile, for example, work skills or work experience. In addition to simply accessing certain profile data points from relevant entity profiles, the recommendation engine 200 may derive certain profile data points based on other information included in the data layer, such as a user's activity and behavior data 212 and social graph data 210.

In an example, one profile data point that may be used to identify similarities between user profiles and a job profile is work experience. Work experience may be included as a profile data point in a user profile directly or may be arrived at indirectly (e.g., by the recommendation engine 200), such as by being measured in the number of years since a user graduated from a selected educational institution or achieved a particular educational level. While work experience, in an example, may not be included as raw data in a user's profile, it may be derived with a calculation if the user's graduation date is specified in the user's profile. In addition, in some examples, the recommendation engine 200 may standardize and/or normalize various profile data points, such as a user's job or position title, or the name of a company at which a user has indicated being employed. In some examples, certain profile data points may be retrieved from external data sources, by using other information included in the user's profile as part of a query to the external data sources.

Once the relevant profiles have been accessed, computed, derived, or retrieved, relevant profiles of the one or more selected users or jobs may be stored as pre-processed profiles (in profile data 208) for the recommendation engine 200. For instance, in the case of user profiles, the process may result in enhanced user profiles that include only the relevant profile data points accessed from a user's profiles as well as any derived or retrieved profile data points. The enhanced profiles may be used by the recommendation engine 200 when the engine 200 compares the relevant profile data points from the job profile against each user profile's set of corresponding profile data points to identify those user profiles with the highest compatibility scores with respect to the job profile.

The system 100 may provide a broad range of other applications and services that allow user the opportunity to share and receive information, often customized to the interests of the user. In some examples, the system 100 may include a photo sharing application that allows users to upload and share photos with other users. In some examples, users may be able to self-organize into groups, or interest groups, around a subject matter or topic of interest. With some embodiments, users may subscribe to or join groups affiliated with one or more companies. For instance, with some embodiments, users of the system 100 may indicate an affiliation with a company at which they are employed, such that news and events pertaining to the company are automatically communicated to the users. In some examples, users may be allowed to subscribe to receive information concerning companies other than the company with which they are employed.

With many of the applications and services provided by system 100, one or more recommendation entities may be involved. For instance, in addition to identifying user profiles that are similar to a job profile, the recommendation engine 200 may be configured and customized to identify groups, companies or photos that are likely to be of interest to a particular user. In an example embodiment, information related to such user activities and interactions may be used to further populate a user profile with profile data points that may then be used in a compatibility analysis with respect to a job profile.

In an example, the social network server 104 may extract job profiles from job listings on various externally hosted third-party jobs listing websites. In some instances, an automated bot (e.g., job extraction module 216) may automatically “crawl” and discover job listings for extraction, while in other instances, job listings may be obtained from a data feed maintained by one or more third-party partners. In any case, the social network server 104 will have a database (e.g., job posting data 214) containing both paid job postings—that is, job postings that have been generated through a job posting module 218 and for which a fee has been obtained—and, unpaid job postings—that is, job postings generated through the job posting module 218 and for which no fee has been obtained and external job postings obtained via extraction from an third-party website external to the social network.

In an example, the social network server 104 may check each external job posting (in job posting data 214) to determine if the external job postings have been posted to the social network for more than a threshold period of time. For example, if an external job posting was first posted to the social network more than two weeks earlier, then the external job posting may be flagged as “old”. For each job posting flagged as old, the job extraction module 216 may visit the external third party website (or websites) from which the job profile associated with the external job posting was extracted and compare the external job posting on the social network with a corresponding job posting on the external third-party. To the extent that any differences are discovered, the job profile (in profile data 208) associated with the external job posting on the social network may be updated to reflect newly extracted current data associated with the corresponding job posting on the external third party website. In an example embodiment, the corresponding job posting may no longer be active (e.g., present) on any of the external third party websites from which job profile data was extracted. In this case the job extraction module 216 may delete (e.g., no longer present to user via any communication channels of the social network server 104) the external job posting from the social network.

In an example embodiment, the job posting module 218 may generate a user interface module(s) 202 wherein a user is provided with options (e.g., buttons or entry fields) for performing at least one of the following: create a job profile for a job posting (paid or unpaid), delete a user-created job posting, edit a job profile for a user-created job posting, set an expiry date for a user-created job posting, renew an expired user-created job posting for a specified period of time, or convert an unpaid job posting into a paid job posting.

In an example embodiment, the job posting module 218 may generate a paid job posting to be presented to users of the social network server 104 via channels of the social network besides a standard “job search” user interface. The other communication channels of the social network server 104 may include: website placement (e.g., placed in a corner of a targeted user's social network homepage), website email direct to targeted user, website messaging to targeted user, or links associated with other job postings. The links associated with other job postings on the social network comprise links to other jobs associated with paid job postings, for example, a link to a job at a company associated with a job posting, a link to receive notices regarding jobs at a company associated with a job posting, a link to other jobs that are similar to a job associated with a job posting, or a link to share a job posting with another user of the social network.

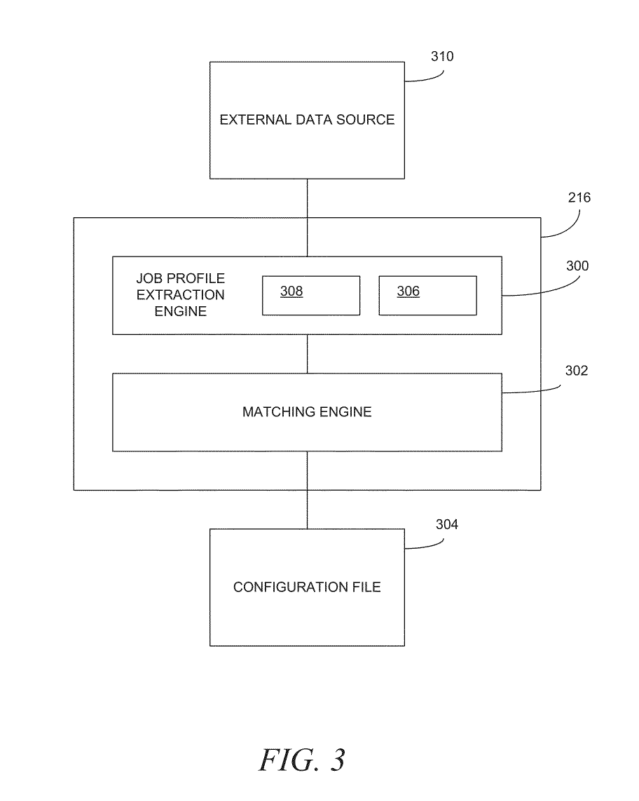

FIG. 3 is a block diagram showing some of the functional components or modules that make up a job extraction module 216, in some examples, and illustrates the flow of data that occurs when performing various operations of a method for extracting job profiles from job listings on external third party websites or otherwise receiving job profile data from another external data source 310. As illustrated, the job extraction module 216 consists of two primary functional modules—a job profile extraction engine 300 and a matching engine 302. The job profile extraction engine 300, under the direction of a particular configuration file 304, may be customized to extract a job profile (e.g., various job profile data points) from a plurality of job listings on various data sources located outside of the social network associated with social network server 104 (e.g., external websites). The job profile extraction engine 300 may then store the extracted job profiles in profile data 208 (FIG. 2). The job profile extraction engine 300 may then generate external job postings (e.g., a job posting generated based on an extracted job profile) on the social network based on the extracted job profiles, and these external job postings may be stored in job posting data 214 (FIG. 2).

The matching engine 302, under the direction of a particular configuration file 304, may be customized to perform a particular type of matching operation that identifies any relevant changes to a job listing on an external data source 310 (e.g., external website) since the most recent extraction of a job profile corresponding to said job listing on the external data source 310. For example, the matching engine 302 may be configured to perform a matching operation for an external job posting on the social network if the job posting has been listed on the social network for more than a specified threshold period of time. The external job posting and relevant related information (e.g., date first posted) may be stored in the job posting data 214. A specific threshold period of time may be set via a configuration file 304 to any desired period of time. Accordingly, depending upon different configuration files 304, the matching engine 302 may be used to compare different external job postings of job posting data 214 as needed. In addition, the profile matching configuration file 304 may specify an algorithm for comparing job listings and generating an overall matching score.

In various examples, the job profile extraction engine 300 may, under the direction of a particular configuration file 304, extract only relevant job profile data points from whatever job listing on an external data source is being processed by the job profile extraction engine 300. So, for example, the job profile extraction engine 300 may extract only the job profile data points that are needed for making the determination of whether a job listing on an external data source is similar enough (e.g., high enough matching score) to an external job posting on the social network. However, in some examples, all job profile data points are extracted, while only certain job profile data points are further processed or refined.

As illustrated in the example of FIG. 3, the job profile extraction engine 300 includes a data point derivation module 306 and a data retrieval module 308. In some examples, the data point derivation module 306 derives certain job profile data points (e.g., salary range) based on the data extracted by the job profile extraction engine 300 (e.g., job title). The data retrieval module 308 of the job profile extraction engine 300 may retrieve various job profile data points from one or more job listings on an external data source 310, such that these retrieved job profile data points may be used to determine the similarity of any two job listings (e.g., an external job posting in job posting data 214 of the social network server 104 and a job posting on an external data source 310). These job profile data points retrieved from the one or more job listings on an external data source 310 may also be used by the data point derivation module 306 to derive further job profile data points.

In addition to deriving various job profile data points, and retrieving various job profile data points, the job profile extraction engine 300 may include logic to normalize or standardize certain job profile data points. For instance, in some examples, a job listing will include a job title. Because job titles may vary from one company to the next, and from one industry to the next, job titles may be normalized or standardized. For example, the simple job title, “analyst” may have very different meanings in different industries. By normalizing and/or standardizing the job titles and then writing the standardized and normalized job titles to each external job listing's job profile, the recommendation engine 200 may make meaningful comparisons, and thereby provide relatively accurate results when presenting user profiles compatible with (e.g., similar to) a job profile.

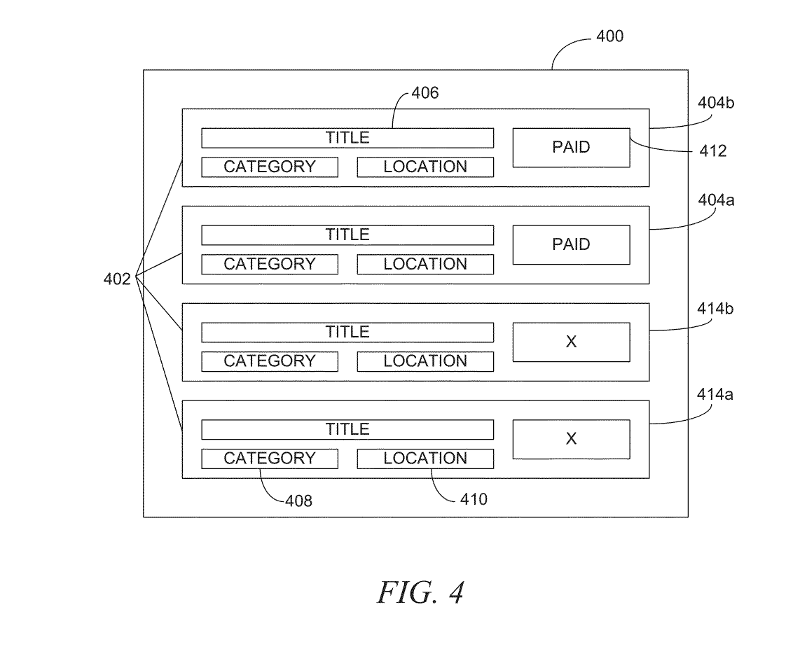

FIG. 4 is a depiction of a user interface screen 400 that may be displayed by the social network on the user device 102 corresponding to a user. In an example, the user interface screen 400 is a sub-portion of a larger user interface module 202 for the job posting module 218. Upon a user of the social network expressing a desire to list paid and unpaid jobs on the social network, the social network server 104 may transmit the user interface module 202 for job posting module 218 to the user device 102, for example together with other social network information that is displayed on a user interface, such as a display screen, of the user device 102.

In the illustrated example, the user interface screen 400 includes a list 402 of fields for entering job profile data points for generating a job profile for a job posting on the social network. In the example, the fields include a job title 406 (e.g., supervisor), a job category 408 (e.g., medical), a job location 410 (e.g., San Jose), and a “paid” label section 412. In the example, the jobs 404a and 404b that have been designated as “paid” by the user are displayed at the top of the list 402, e.g., most prominently on the list 402. In the example, unsponsored jobs 414a, 414b are displayed less prominently than the sponsored jobs 404a, 404b. In various examples, unsponsored jobs 414a, 414b may not incorporate a label section 412 or include a label section 412 with an indication that the job is unsponsored.

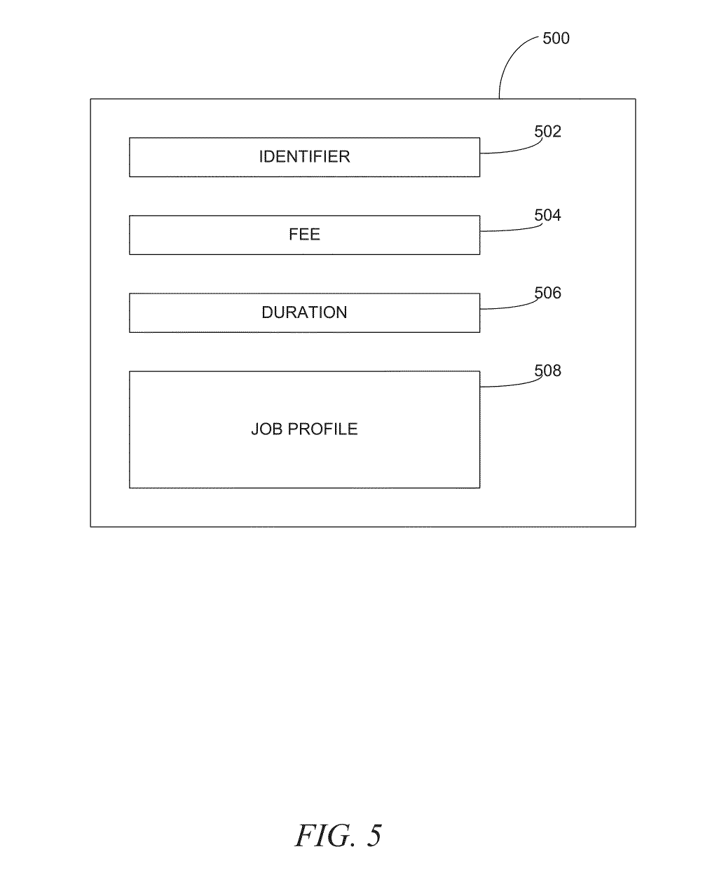

FIG. 5 is an illustration of an interface screen 500 to create a social network publishing campaign for a paid job posting. The interface screen 500 may be specifically adapted for use by customers, such as job posting entities, though the interface screen 500 may be utilized by social network administrators or any other party for whom access to create or modify a publishing campaign is granted. The interface screen 500 may be displayed on a web browser or other program or application for displaying and interfacing with information known in the art. The interface screen 500 may function as a portion of the user interface module(s) 202 for job posting module 218.

The interface screen 500 includes an identifier field 502 to enter an identifier, such as a name, for the publishing campaign (e.g., “regional manager search”). The identifier may be descriptive of the campaign and/or may uniquely identify the campaign. The interface screen 500 further includes a fee field 504 in which a fee amount or range of fee bids for an auction format may be entered. The level of publication via other communication channels of the social network may be based on the fee amount paid for a job posting to the social network. A duration field 506 may be utilized to limit the amount of time during which the job posting will be published across the social network's communication channels. The time period entered into the duration field 506 may be linked to a fee to be paid for a publishing campaign. Job profile field 508 may be utilized to upload job profile data points (e.g., via user interface screen 400) or select a job profile that has already been entered into the system 100, e.g., stored in profile data 208. In various examples, a single publishing campaign may include multiple job profiles, with each user selection (or input) of a job profile counting against the limitations for the publishing campaign as a whole.

The interface screen 500 may also be utilized to modify existing publishing campaigns. Existing publishing campaigns may be lengthened or shortened, have fees and/or fee bids increased or decreased, and have job profiles added or removed from the publishing campaign. Under certain business conditions, a job poster may be prevented from adjusting a publishing campaign once the campaign has begun, in which case the interface screen 500 may reflect an inability to change publishing campaign parameters. In various examples, an administrator of the social network may always be given access to modify a publishing campaign.

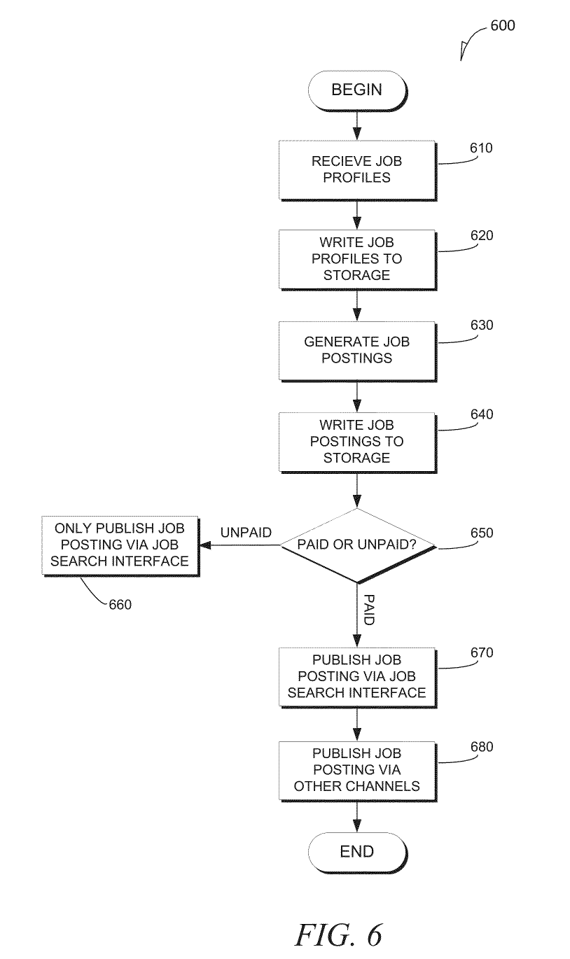

FIG. 6 is a flow diagram illustrating an example of the method operations involved in a method 600 for hosting paid and unpaid job postings on a social network. In some examples, some of the method operations illustrated in FIG. 6 may be performed offline by means of a batch process that is performed periodically (e.g., two times a day, daily, weekly, and so forth), while in other examples, the method operations may be performed online and in real-time as requests for similar user profiles and job profiles are being received and processed.

At operation 610, the social network server 104 may receive, via a user interface module 202 generated by a job posting module 218, a job profile for each of a plurality of job postings to the social network. The job profiles may include several job profile data points including the name of the company or organization at which the job opening is available, the job title for the job opening, a description of the job functions and the required or recommended skills, education, certifications and/or expertise.

At operation 620, after a user enters the relevant job profile data points via the user interface module 202, a job profile including the job profile data points may be generated and stored in job profile data 208.

At operation 630, a job posting may be generated, based on the job profile generated at operation 620, for presentation (via publishing module 206) to users of the social network with which the job posting module 218 is integrated.

At operation 640, after a job posting has been generated based on the extracted job profile, the job posting may be stored in job posting data 214.

At operation 650, the publishing module 206 of social network server 104 may determine whether each job profile received via the job posting module 218 is for an unpaid job posting to the social network, and if so, the job posting may be presented to user of the social network only via a standard “job search” user interface module(s) 202 at operation 660. In this way users of the social network that are actively searching for jobs (e.g., via a job search module in application server modules 204) maybe presented with the unpaid job posting, to the extent that it matches the user's search criteria. However, the unpaid job posting will not be published over other communication channels via the social network server 104's publishing module 206.

At operation 650, the publishing module 206 may determine whether each job profile received via the job posting module 218 is for a paid job posting to the social network, and if so, the job posting may be presented to users of the social network via the standard “job search” user interface module 202 at operation 670, so that users of the social network that are actively searching for jobs may be presented with the unpaid job posting. Furthermore, at operation 680, payment of a fee will entitle the job posting to be presented to users of the social network over other communication channels of the social network via the publishing module 206. For example, a paid job posting may be presented to a user via a direct e-mail to the user or via placement of the posting on the user's social network “homepage”, if it is determined that the job posting may be attractive to the user based on a comparison (e.g., by recommendation engine 200) of the user's profile and the job profile associated with the job posting.

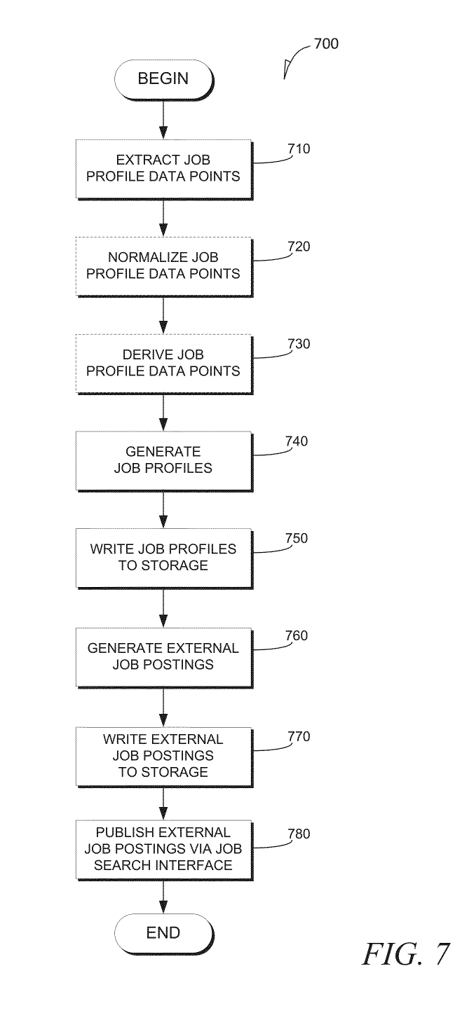

FIG. 7 is a flow diagram illustrating an example of the method operations involved in a method 700 for extracting job profiles from external data sources and hosting unpaid job postings on a social network based on the extracted job profiles. In some examples, some of the method operations illustrated in FIG. 7 may be performed offline by means of a batch process that is performed periodically (e.g., two times a day, daily, weekly, and so forth), while in other examples, the method operations may be performed online and in real-time as requests for similar user profiles and job profiles are being received and processed.

At operation 710, the social network server 104 may receive, via a job extraction module 216, a job profile (comprising job profile data points) for each of a plurality of job listings on a third party website outside of the social network (e.g., external data source 310 of FIG. 3). The job profiles may include several job profile data points including the name of the company or organization at which the job opening is available, the job title for the job opening, a description of the job functions and the required or recommended skills, education, certifications and/or expertise.

At operation 720, an optional step of normalizing job profile data points may be performed. In this step, certain job profile data points that may vary in meaning across different categories of jobs may be normalized or standardized so that their meaning is clearer to a user of the social network in the context of a job search.

At operation 730, an optional step of deriving job profile data points may be performed. In this step, certain job profile data points may be derived based on the data points already available for a job profile. For example, a job profile data point related to job location may be derived based on a job profile data point regarding the company that listed the job, if the company's location is known.

At operation 740, after the relevant job profile data points have been extracted and optionally normalized and/or derived, a job profile including the job profile data points may be generated. At operation 750, the job profile generated at operation 740 may be stored in job profile data 208.

At operation 760, an external job posting may be generated, based on the job profile generated at operation 740, for presentation (via publishing module 206) to users of the social network with which the job posting module 218 is integrated.

At operation 770, after a job posting has been generated based on the job profile generated at operation 740, the job posting may be stored in job posting data 214.

At operation 780, the publishing module 206 of social network server 104 may publish the job posting generated at operation 760 only via a standard “job search” user interface module(s) 202. In this way users of the social network that are actively searching for jobs (e.g., via a job search module in application server modules 204) maybe presented with the external job posting, to the extent that it matches the user's search criteria. However, the external job posting will not be published over other communication channels via the publishing module 206.

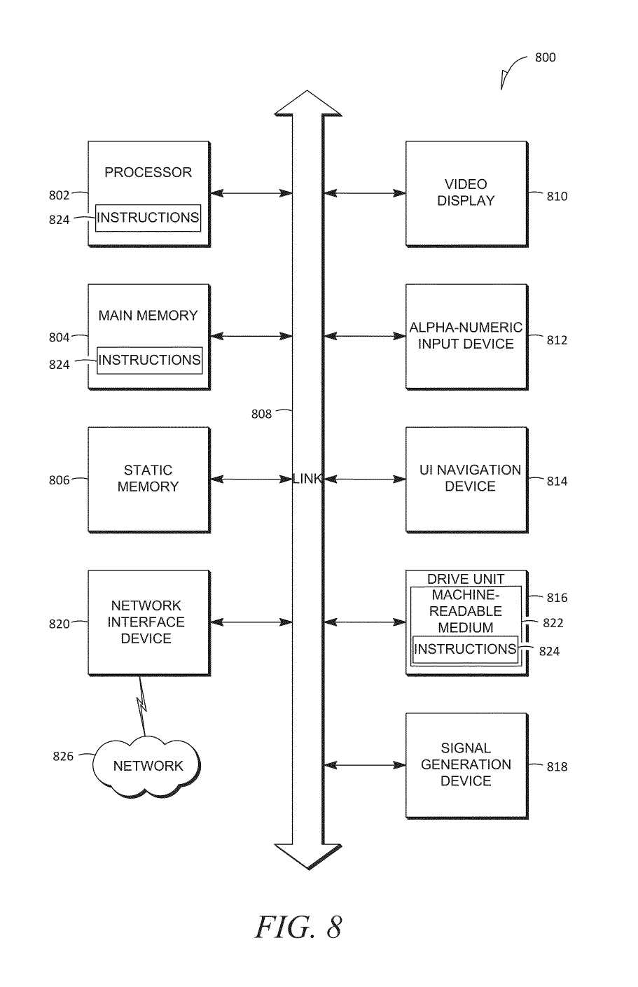

FIG. 8 is a block diagram illustrating components of a machine 800, according to some example examples, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system and within which instructions 824 (e.g., software) for causing the machine 800 to perform any one or more of the methodologies discussed herein may be executed. In alternative examples, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a video display 810 (e.g., a plasma display panel (PDP), a light emitting diode (LED) display, a liquid crystal display (LCD), a projector, or a cathode ray tube (CRT)). The machine 800 may also include an alphanumeric input device 812 (e.g., a keyboard), a cursor control (or user interface navigation) device 814 (e.g., a mouse, a touchpad, a trackball, a joystick, a motion sensor, or other pointing instrument), a drive unit 816, a signal generation device 818 (e.g., a speaker), and a network interface device 820.

The drive unit 816 includes a machine-readable medium 822 on which is stored the instructions 824 (e.g., software) embodying any one or more of the methodologies or functions described herein. The instructions 824 may also reside, completely or at least partially, within the main memory 804, within the processor 802 (e.g., within the processor's cache memory), or both, during execution thereof by the machine 800. Accordingly, the main memory 804 and the processor 802 may be considered as machine-readable media. The instructions 824 may be transmitted or received over a network 826 via the network interface device 820.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 822 is shown in an example to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., instructions 824) (e.g., software) for execution by a machine (e.g., machine 800), such that the instructions, when executed by one or more processors of the machine (e.g., processor 802), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A memory device communicatively coupled to a machine including at least one processor, the memory device comprising instructions which, when performed by the at least one processor, cause the machine to:
receive, via a job posting user interface, a job profile for each of a plurality of job postings to a social network; and
for each job profile:
based on determining that the job profile is for an unpaid job posting to the social network, present the job posting to users of the social network only via a job search user interface; and
based on determining that the job profile is for a paid job posting to the social network, present the job posting to users of the social network via the job search user interface and via at least one other communication channel of the social network.

2. The memory device of claim 1, wherein the memory device further comprises instructions that cause the machine to:
extract, from at least one external website, a job profile for each of a plurality of external job postings to the social network; and
present the external job postings to users of the social network only via the job search user interface.

3. The memory device of claim 2, wherein the memory device further comprises instructions that cause the machine to:
based on determining that an external job posting has been posted to the social network for a threshold period of time, check the at least one external website from which a corresponding job profile was extracted to identify any differences between the external job posting and a corresponding job posting on the at least one external website; and
update the corresponding job profile for the external job posting on the social network based on the identified differences.

4. The memory device of claim 3, wherein the memory device further comprises instructions that cause the machine to delete the external job posting based on the identified differences.

5. The memory device of claim 2, wherein the job posting user interface enables a user to perform at least one of the following: create a job posting, delete a user-created job posting, edit a job profile for a user-created job posting, set an expiry date for a user-created job posting, renew an expired user-created job posting for a specified period of time, or convert an unpaid job posting to a paid job posting.

6. The memory device of claim 1, wherein:
the at least one other communication channel of the social network includes at least one of: website placement, website email, website messaging, or links associated with other job postings on the social network; and
the links include at least one of: a link to other jobs at a company associated with a job posting, a link to receive notices regarding jobs at a company associated with a job posting, a link to other jobs that are similar to a job associated with a job posting, or a link to share a job posting with another user of the social network.

7. The memory device of claim 6, wherein the memory device further comprises instructions that cause the machine to present a paid job posting to a user of the social network via the at least one other communication channel of the social network based on a comparison of a job profile for the paid job posting to a user profile of the user of the social network.

8. A system, comprising:
at least one processor; and
a memory device comprising instructions which, when performed by the at least one processor, cause the at least one processor to:
receive, via a job posting user interface, a job profile for each of a plurality of job postings to a social network; and
for each job profile:
based on determining that the job profile is for an unpaid job posting to the social network, present the job posting to users of the social network only via a job search user interface; and
based on determining that the job profile is for a paid job posting to the social network, present the job posting to users of the social network via the job search user interface and via at least one other communication channel of the social network.

9. The system of claim 8, wherein the memory device further comprises instructions that cause the at least one processor to:
extract, from at least one external website, a job profile for each of a plurality of external job postings to the social network; and
present the external job postings to users of the social network only via the job search user interface.

10. The system of claim 9, wherein the memory device further comprises instructions that cause the at least one processor to:
based on determining that an external job posting has been posted to the social network for a threshold period of time, check the at least one external website from which a corresponding job profile was extracted to identify any differences between the external job posting and a corresponding job posting on the at least one external website; and
update the corresponding job profile for the external job posting on the social network based on the identified differences.

11. The system of claim 10, wherein the memory device further comprises instructions that cause the at least one processor to delete the external job posting based on the identified differences.

12. The system of claim 9, wherein the memory device further comprises instructions that cause the at least one processor to provide a user interface for a user to perform at least one of the following: create a job posting, delete a user-created job posting, edit a job profile for a user-created job posting, set an expiry date for a user-created job posting, renew an expired user-created job posting for a specified period of time, or convert an unpaid job posting to a paid job posting.

13. The system of claim 8, wherein:
the at least one other communication channel of the social network includes at least one of: website placement, website email, website messaging, or links associated with other job postings; and
the links include at least one of: a link to other jobs at a company associated with a job posting, a link to receive notices regarding jobs at a company associated with a job posting, a link to other jobs that are similar to a job associated with a job posting, or a link to share a job posting with another user of the social network.

14. The system of claim 13, wherein the memory device further comprises instructions that cause the at least one processor to:
compare a job profile for a paid job posting to a user profile of a user of the social network; and
present the paid job posting to the user of the social network via the at least one other communication channel of the social network based on the comparison.

15. A method comprising:
receiving, via a job posting user interface, a job profile for each of a plurality of job postings to a social network; and
for each job profile:
based on determining that the job profile is for an unpaid job posting to the social network, presenting the unpaid job posting to users of the social network only via a job search user interface; and
based on determining that the job profile is for a paid job posting to the social network, presenting the paid job posting to users of the social network via the job search user interface and via at least one other communication channel of the social network.

16. The method of claim 15, further comprising:
extracting, from at least one external website, a job profile for each of a plurality of external job postings to the social network; and
presenting the external job postings to users of the social network only via the job search user interface.

17. The method of claim 16, further comprising:
based on determining that an external job posting has been posted to the social network for a threshold period of time, check the at least one external website from which a corresponding job profile was extracted to identify any differences between the external job posting and a corresponding job posting on the at least one external website; and
update the corresponding job profile for the external job posting on the social network based on the identified differences.

18. The method of claim 16, wherein the job posting user interface enables a user to perform at least one of the following: create a job posting, delete a user-created job posting, edit a job profile for a user-created job posting, set an expiry date for a user-created job posting, renew an expired user-created job posting for a specified period of time, or convert an unpaid job posting to a paid job posting.

19. The method of claim 15, wherein:
the at least one other communication channel of the social network includes at least one of: website placement, website email, website messaging, or links associated with other job postings; and
the links include at least one of: a link to other jobs at a company associated with a job posting, a link to receive notices regarding jobs at a company associated with a job posting, a link to other jobs that are similar to a job associated with a job posting, or a link to share a job posting with another user of the social network.

20. The method of claim 19, further comprising:
presenting the paid job posting to a user of the social network via the at least one other communication channel of the social network based on a comparison of a job profile for the paid job posting to a user profile of the user of the social network.
